(19) United States
(12) Patent Application Publication
(10) Pub. No.: US 2003/0050352 A1
(43) Pub. Date: Mar. 13, 2003

(54) Foamed Polymer System employing blowing agent performance enhancer

(75) Inventors: Thomas Guenther, Romeo, MI (US); David Carlson, Rochester Hills, MI (US)

Correspondence Address: Theresa A. Orr, Dobrusin & Thennisch PC, Suite 311, 401 South Old Woodward Avenue, Birmingham, MI, 48009, US

(73) Assignee: Symyx Technologies, Inc.

(21) Appl. No.: 10/233,919

(22) Filed: Sep. 3, 2002

Related U.S. Application Data
(60) Provisional application No. 60/317,009, filed on Sep. 4, 2001.

(51) Int. Cl. C08J 9/00

(52) U.S. Cl. 521/50

(57) ABSTRACT

A foamed polymer system includes a blowing agent performance enhancer to ensure that the foaming rate of the blowing agent is sufficient to achieve the desired foam characteristics and to improve control over the blowing agent performance. The system includes a combination of an azo-type compound with a metallic salt of an organic acid in the manufacture of the foamed polymer.

### TECHNICAL FIELD

The present invention relates generally to foamed polymer systems and more particularly to polymer systems employing a performance enhancer for a blowing agent.

### BACKGROUND ART

It is well known in the plastics and polymer arts to employ blowing agents in order to generate foaming in a material. Typically a blowing agent is an agent that will liberate gas, which in turn results in the formation of pores or cells, thereby leading to a foamed polymer.

Unfortunately in certain polymer systems, the foaming rate from using a specific concentration of blowing agent is insufficient to achieve the desired density, density gradient, pore size or other foam or foamable characteristic in the resulting material. Accordingly, there is a need to be able to enhance or tune the performance of blowing agents in such systems and to achieve greater control over the resulting material properties.

### SUMMARY OF THE INVENTION

The present invention provides a novel and unique approach to enhance or tune the performance of polymer foam systems, particularly through the control of the chemistry of the starting materials. In general, the present invention employs, in combination, a chemical blowing agent and a performance enhancer according to the present invention in the manufacture of polymer foam. More particularly, the present invention pertains to the employment of a combination of azo-type compounds with a metallic salt of an organic acid in the manufacture of a foamed polymer selected from the group consisting of foamable elastomers, thermoplastics, thermosets and mixtures thereof (e.g. without limitation, plastics containing polyolefins, epoxies, styrenes, vinyls (such as PVC), or the like). Employment of the system of the present invention facilitates the manufacture of high integrity foamed polymer articles. Less energy and shorter processing times are required to make such parts than in the absence of the performance enhancer. Improved control over uniformity of cell size, shape and resulting densities is also possible. Further, the likelihood of corrosion is also reduced because the invention allows greater control over the pH of the system and the process. Moreover, the present systems offers additional advantages of relatively low toxicity, especially for systems such as PVC foam, which ordinarily require lead or cadmium-based blowing agent systems.

### DETAILED DESCRIPTION OF PREFERRED EMBODIMENT

One embodiment of the present invention is premised upon the combination of a metallic salt of an organic acid with a blowing agent for making a foamed polymer. In a more particular aspect, the metallic salt of organic acid is used in combination with an azo-type blowing agent.

In general, the blowing agents of the present invention are chemicals that react in the presence of heat, temperature, pressure, chemistry, or other external factor and gas. The gas in turn leads to the formation of pores or cells in a foamed material. The foamed materials generally are stable at room temperature. They may be open or closed cell, soft or hard foam, or rigid or flexible foam. The foamed materials of the present invention may be further characterized by a variety of degrees of soft or hard foam, or rigid or flexible foam, depending upon the desired application.

To illustrate, azo-type blowing agents are well known in the art. Without intending to be limited thereby, examples of various such agents include azodicarbonamide. Of course, the skilled artisan will appreciate that other azo-type agents exist and fall within the scope of the present invention as well as other blowing agents commonly referred to as DNPT-type agents (dinitrosopentamethylenetetramine) and OBSH-type agents, such as oxi-bis (benzylsulphonyl)—hydrazide and oxibis benzene-sulfonyl hydrazide, also known as Oxybis (benzene) sulfonyl hydrazide. Still further blowing agents suitable for use and application in the present invention include TSH, Toluene sulfonyl hydrazide.

The metallic salt of organic acid typically employs as its metallic component an element selected from the group consisting of alkali metals, alkali earth metals and mixtures or combinations thereof. More specifically, the metallic component is selected from the group consisting of zinc, potassium, lithium, sodium, calcium, magnesium and mixtures thereof. In a highly preferred embodiment the selected metal is sodium.

The organic acid component preferably is selected from organic acids having carbon ranging from about 2 to about 22 atoms per molecule, and more preferably from about 2 to about 8 atoms per molecule. Longer chain molecules are also possible. For instance, some salts of fatty acids may be suitably employed in the present invention. Examples of particularly preferred acid components include without limitation, acetates, stearates, proprionates or mixtures thereof. More particularly, the performance enhancer disclosed in the present invention may be selected from the group consisting of sodium acetate, potassium acetate, calcium acetate, and all possible hydrates of those salts.

The metallic salt of organic acid may be provided in its anhydrous form (subject to conventional handling) or as a hydrate or multiple hydrate such as trihydrate. Preferably the melting point of the performance enhancer is lower than other components with which it will contact during processing to facilitate dispersion. The relative amounts (by weight) of metallic salt of organic acid to blowing agent preferably ranges from about 3:5 to about 1:20 or 1:25 and more preferably is about 1:5.

In a typical manufacture process of articles according to the present invention, the blowing agent and the performance enhancer may be added to the starting materials to be foamed either separately or as part of an admixture, which may or may not be further compounded with the polymer to be foamed and optionally any other ingredients.

The type of polymer to be foamed is not critical. Preferably the polymer is melt processable between a temperature of about 250° F. to about 450° F., and will exhibit a viscosity sufficient to enable pores to form readily upon liberation of gas from within the materials. By way of example, without limitation, the performance enhancers may be employed to make foamed olefin-containing polymers, vinyl-containing polymers, epoxy-containing polymers or the like. Of course, other polymer systems likewise advantageously may employ the agent of the present invention. By way of example, without limitation, a compounded admixture may be prepared by using a high shear mixer (e.g. Henschel mixer). The compounded admixture is then introduced into a mold and foamed. One or more elevated temperatures may suitably be employed for foaming (e.g. heating to about 210° C. or lower) or exposure to any other heat or energy source.

One of the advantageous features of the present invention is that the blowing agent performance enhancer generally has a lower melting point (or possibly viscosity) than the remaining materials in the admixture. The performance enhancer thus disperses through the admixture with a relatively high level of uniformity during processing, thereby affording enhanced control over foaming throughout the article being foamed.

In a particularly preferred embodiment, the present invention provides a formulation or material consisting of the following components as set forth in the table below:

| | | | | phr |
|---|---|---|---|---|
| | | | | (parts per |
| | | Mass | Weight % | hundred |
| Chemical Name | Chemical Description | (g) | (%) | rubber) |
| Keltan 5808 | EPDM Rubber | 90.3 | 7.07 | 25.80 |
| Vistalon 7800 | EPDM Rubber | 90.3 | 7.07 | 25.80 |
| Vistalon 2504 | EPDM Rubber | 169.3 | 13.25 | 48.39 |
| Escorene MVO | EVA Resin | 57.8 | 4.53 | 16.53 |
| 2514 | | | | |
| Rosswax 3002 | Microcrystalline Wax | 37.2 | 2.91 | 10.63 |
| CUDD PM | Accelerator for Sulfur Cure | 2.4 | 0.18 | 0.67 |
| | Systems | | | |
| Sodium Acetate | Blowing Agent Activator | 17.1 | 1.34 | 4.89 |
| Nevex 100 | Hydrocarbon Resin | 132.1 | 10.34 | 37.76 |
| Super Nevtac 99 | Hydrocarbon Resin | 34.2 | 2.67 | 9.76 |
| Dry Pure 2 | Recycled Filler | 311.8 | 24.40 | 89.10 |
| Zoco 100 | Accelerator for Sulfur Cure | 16.6 | 1.30 | 4.74 |
| | Systems/Activator for | | | |
| | Blowing Agents | | | |
| MBTS Powder | Accelerator for Sulfur Cure | 7.7 | 0.60 | 2.21 |
| | Systems | | | |
| Sulfur | Crosslinking Agent | 7.7 | 0.60 | 2.21 |
| BZX Powder | Accelerator for Sulfur Cure | 7.7 | 0.60 | 2.21 |
| | Systems | | | |
| BIK OT | Blowing Agent Activator | 4.3 | 0.33 | 1.22 |
| Ficel EPC | Modified Azodicarbonamide | 52.2 | 4.08 | 14.92 |
| | Blowing Agent | | | |
| Celogen AZ 120 | Azodicarbonamide Blowing | 52.3 | 4.09 | 14.95 |
| | Agent | | | |
| Sunpar 115 | Process Oil | 117.0 | 9.15 | 33.43 |
| Indopol H-1500 | Polybutene | 70.0 | 5.48 | 20.00 |
| Total | | 1278.0 | 100.00 | |

It should also be appreciated that the present invention may be used and applied to any type of system or methodology to mix polymers including lower shear double arm mixture, a twin screw extruder, a single screw extruder, or other polymer compounding equipment. Once formed through the selected polymer compounding or mixing methodology, the compounded admixture may be foamed for certain applications or left in latent form to undergo a foaming process during a later process utilized in the manufacturing of a wide array of goods and products, including, but not limited to, parts and products for use in automotive, aerospace, or marine vehicles and parts thereof.

It should also be appreciated that the present invention can be utilized in conjunction with a variety of foamable and foam-in-place material formulations that would traditionally incorporate the use of a blowing agent or an encapsulated blowing agent. For example, the present invention can be used as a component in epoxy-based or PVC-based foam-in-place formulations used to formulate expandable materials and structural foams used to reinforce, stiffen, sound absorb, and/or dampen a wide array of goods and products, such as furniture, appliances, and transportation vehicles including automotive aerospace, and marine vehicles. In such applications and formulations, the blowing agent performance enhancer of the present invention may serve to reduce the amount of blowing agent by up to 70% or reduce the amount of needed encapsulated blowing agent which can provide more flexibility to calculated reaction times and reduce potential charring or burning caused by the exothermic reaction. An example of such as epoxy-based foam in place formulations are provided by L&L Products, Inc. of Romeo, Mich. and are disclosed in commonly-assigned U.S. Ser. No. 09/847,252 for a Two Component (Epoxy/Amine) Structural Foam-In-Place Material filed May 2, 2001, U.S. Provisional Serial No. 60/324,486 for Creation of Epoxy-Based Foam-In-Place Material Using Encapsulated Metal Carbonate filed Sep. 24, 2001, and U.S. Ser. No. 10/119,446 for Homopolymerized Epoxy-Based Foam-In-Place Material filed Apr. 10, 2002, all of which are expressly incorporated by reference herein.

In such epoxy based foam-in-place formulations, the preferred epoxy resin has a number average molecular weight of from about 350 to about 600 and, on average, each molecule of epoxy has from about 1.8 to about 2.5 epoxide functional groups. The preferred epoxy resin has a viscosity of from about 5,000 to 100,000 cps (Brookfield viscosity) at 70° F. and a specific gravity of from about 1.0 to about 1.4. In those applications where the performance enhancer is used in conjunction with, or as a replacement of, a physical blowing agent, the epoxy or resin may be formulated with both a physical blowing agent and the performance enhancer of the present invention.

It should be understood that various alternatives to the embodiments of the invention described herein may be employed in practicing the invention. It is intended that the following claims define the scope of the invention and that the method and apparatus within the scope of these claims and their equivalents be covered thereby.

What is claimed is:

1. A foamed polymer article, comprising:
a polymer material having a plurality of cells defined therein wherein said cells are the product of an interaction involving:
a blowing agent; and
a blowing agent performance enhancer.

2. The article according to claim 1, wherein said blowing agent is an azo-type blowing agent.

3. The article according to claim 1, wherein said blowing agent is selected from the group consisting of a dinitrosopentanethylenetetramine-type blowing agent, an oxibis benzene-sulfonyl hydrazide-type blowing agent, a toluene sulfonyl hydrazide-type blowing agent, and a rubber type blowing agent.

4. The article according to claim 1 wherein said blowing agent performance enhancer is a metallic salt of an organic acid.

5. The article according to claim 1 wherein said blowing agent is azo-bis-dicarbonamide.

6. The article according to claim 4. wherein said metallic component of said metallic salt is one selected from the group consisting of alkali metals, alkali earth metals and mixtures thereof.

7. The article according to claim 6 wherein said metallic component of said metallic salt is selected from the group consisting of zinc, potassium, lithium, sodium, calcium, magnesium and mixtures thereof.

8. The article according to claim 7, wherein said metallic component of said metallic salt is sodium.

9. The article according to claim 4, wherein said organic acid component of said performance enhancer has about 2 to about 22 carbon atoms per molecule.

10. The article according to claim 9, wherein said organic acid component of said performance enhancer has about 2 to about 22 carbon atoms per molecule.

11. The article according to claim 10, wherein said organic acid component of said performance enhancer is selected from the group consisting of acetates, stearates, propionates and mixtures thereof.

12. The article according to claim 11, wherein said organic acid component of said performance enhancer is an acetate.

13. The article according to claim 4, wherein said performance enhancer is selected from the group consisting of sodium acetate, potassium acetate, and calcium acetate.

14. The article according to claim 2, further wherein said performance enhancer is selected from the group consisting of sodium acetate, potassium acetate, and calcium acetate.

15. The article according to claim 5, further wherein said performance enhancer is sodium acetate.

16. The article according to claim 1, wherein the amount of said performance enhancer to the amount of said blowing agent is about 1:25.

17. The article according to claim 16 wherein the amount of said blowing agent comprises an azobisdicarbonamide.

18. A blowing agent performance enhancement system for making foamed polymer articles, comprising:
an azo-type blowing agent; and
an organic acid of a metallic salt.

19. The system according to claim 18, wherein said blowing agent is azodicarbonamide and said organic acid of a metallic salt is sodium acetate.

20. A foamed polymer article, comprising:
a cellular polymer foam structure prepared by the interaction of:
an azobisdicarbonamide and sodium acetate.

21. The article according to claim 20 wherein said ratio of azobisdicarbonamide to sodium acetate is about 6:1.
